(19) United States
(12) Patent Application Publication
(10) Pub. No.: US 2024/0084610 A1
(43) Pub. Date: Mar. 14, 2024

(54) STRUCTURE ASSEMBLING ROBOT

(71) Applicants: Seyed kambiz Ghaemi osguoie, Tehran (IR); Amin Mostafavi, Tehran (IR)

(72) Inventors: Seyed kambiz Ghaemi osguoie, Tehran (IR); Amin Mostafavi, Tehran (IR)

(73) Assignees: Seyed kambiz Ghaemi osguoie, Tehran (IR); Amin Mostafavi, Tehran (IR)

(21) Appl. No.: 18/515,404

(22) Filed: Nov. 21, 2023

Related U.S. Application Data
(63) Continuation-in-part of application No. PCT/IB2022/050006, filed on Jan. 2, 2022.
(60) Provisional application No. 63/192,114, filed on May 24, 2021.

(51) Int. Cl. E04G 21/16; B25J 9/12; B25J 11/00; B25J 18/02

(52) U.S. Cl. CPC E04G 21/16; B25J 9/123; B25J 11/005; B25J 18/025

(57) ABSTRACT

A structure assembling robot may include an elongated telescopic bridge, at least one beam gripping mechanism mounted on the elongated telescopic bridge, a beam lifting assembly, a clamp rotatably mounted on the elongated telescoping bridge, and at least one welding arm assembly. The beam gripping mechanism may be configured to be mounted around a structural beam and allow for structure assembling robot to move on the structural beam. The beam lifting assembly configured to lift a structural beam to the position of the structure assembling robot. The at least one welding arm assembly may be configured to weld and mount the lifted structural beam to a building structure while the clamp fixes the lifted structural beam in a desired position and a desired orientation relative to the building structure.

### CROSS-REFERENCE TO RELATED APPLICATION

This application is a continuation-in-part of PCT/IB2022/050006 filed on Jan. 2, 2022, and entitled “STRUCTURE ASSEMBLING ROBOT” which claims the benefit of priority from pending U.S. Provisional Patent Application Ser. No. 63/192,114, filed on May 24, 2021, and entitled “MOBILE STRUCTURE ASSEMBLER ROBOT,” which are both incorporated herein by reference in their entirety.

### TECHNICAL FIELD

The present disclosure relates to mobile robotic systems, and particularly relates to automation in construction utilizing robotics and artificial intelligence. More particularly, the present disclosure relates to autonomous welders, integrated cranes, and other subsystems mounted on a mobile chassis moveable on metallic and non-metallic structures.

### BACKGROUND

Structures are integral parts of buildings that may be present in residential buildings to oil docks. Manufacturing structures is an intensive yet hazardous process which significantly determines the resistance of the whole building against potentially destructive occurrences such as earthquakes, typhoons, landslides, etc.

The drawbacks of conventional methods in which human welders play a significant role may include the human welder's presence in heights increasing the danger of falling, inhaling toxic welding emissions, occupational asthma, electrocution, etc. Apart from these possible issues, human welder' require ongoing high wages and their fatigue might lead to work quality decrease and human errors.

To improve the pace and the accuracy of a building process, structures may be prefabricated and later assembled by utilizing screw fasteners which may also improve fire resistance and may decrease labor demands, still requiring presence of a human workforce at significant heights, although less than other conventional approaches. Prefabrication may be performed by utilizing automated welding systems, which may further improve the outcome.

On-site construction may be automated by using huge gantry or giraffe-type systems which circumscribe the whole building. These systems almost eliminate a workforce demand; however, they may be highly costly and may need huge prior arrangements in their stationary subsystems like railing and power provision. Their usage in large and Highrise buildings is almost infeasible. Also, the necessity of prior railing may prevent the use of these systems in continuous building blocks.

Gantry robots are generally utilized for 3D printing building structures and sometimes for assembling structural parts. Gantry robots require separate rails to move, which must be installed separately. Gantry robots circumscribe the building, making a particular gantry robot suitable for a building with specific dimensions. It is also impossible to use it for high-rise buildings. Furthermore, gantry robots need much space around a building due to rails and side supporting members around the building structure. For this reason, a gantry robot cannot be used in places where buildings are built close to each other. As gantry robots circumscribe the structure of the building, the sizes of gantry robots directly depend on the dimensions of a building, which significantly has high economic costs, especially for high-rise buildings (because each building size needs a gantry robot in specific size).

A potential solution to the drawbacks of the automated system explained above may be a robot small enough to be able to easily navigate inside a building on its own by grabbing a structure—instead of moving on rails—equipped with autonomous welding and navigation systems which may enable it to locate to-be-welded spots by priorly importing a computer model of a building. The robot may also be equipped with a crane to let it lift beams to a needed location and weld them.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a structure assembling robot. An exemplary structure assembling robot may include an elongated telescopic bridge with an adjustable length along a longitudinal axis of the elongated telescopic bridge, at least one beam gripping mechanism mounted on the elongated telescopic bridge. At least one exemplary beam gripping mechanism may include a main ring rotatably coupled to the elongated telescopic bridge, the main ring configured to be rotatable about a rotational axis perpendicular to the longitudinal axis of the elongated telescopic bridge, the rotational axis parallel with a circular cross-sectional plane of the main ring.

An exemplary main ring may include a first curved section, and a second curved section hinged to the first curved section, the second curved section and the first curved section configured to be pivotable relative to each other about a hinge axis perpendicular to the circular cross-sectional plane of the main ring.

At least one exemplary beam gripping mechanism may further include a first continuous track assembly disposed within the main ring and coupled to the first curved section, and a second continuous track assembly disposed within the main ring and coupled to the second curved section. An exemplary first continuous track assembly and an exemplary second continuous track assembly may be configured to engage opposing surfaces of a beam responsive to the beam received within the main ring.

An exemplary structure assembling robot may further include a beam lifting assembly. An exemplary beam lifting assembly may include a main pole attached to the elongated telescopic bridge, the main pole extended from the elongated telescopic bridge along an axis parallel to the rotational axis, a cable, a cable actuating mechanism coupled to a distal end of the main pole, the cable actuating mechanism further coupled to the cable and configured to extend/retract the cable, and an end-effector coupled to a distal end of the cable, the end-effector configured to grab a beam.

An exemplary structure assembling robot may further include a clamp rotatably mounted on the elongated telescoping bridge. An exemplary clamp may include a fixed clamp section, a moveable clamp section coupled to the fixed clamp section, and a linear actuator coupled between the fixed clamp section and the moveable clamp section, the linear actuator configured to drive a linear movement of the moveable clamp section relative to the fixed clamp section.

An exemplary structure assembling robot may further include at least one welding arm assembly. An exemplary welding arm assembly may include a robotic arm with six degrees of freedom rotatably attached to the elongated telescopic bridge, and a welding end-effector coupled to a distal end of the robotic arm.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently exemplary embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1A illustrates a perspective view of a structure assembling robot, consistent with one or more exemplary embodiments of the present disclosure;

FIG. 1B illustrates a top view of a structure assembling robot, consistent with one or more exemplary embodiments of the present disclosure;

FIG. 1C illustrates a sectional side view of a structure assembling robot, consistent with one or more exemplary embodiments of the present disclosure;

FIG. 2A illustrates a sectional top view of a beam gripping mechanism, consistent with one or more exemplary embodiments of the present disclosure;

FIG. 2B illustrates a perspective view of a beam gripping mechanism, consistent with one or more exemplary embodiments of the present disclosure;

FIG. 2C illustrates a perspective view of a first curved section of a beam gripping mechanism, consistent with one or more exemplary embodiments of the present disclosure;

FIG. 2D illustrates a perspective view of a structural beam embraced by a beam gripping mechanism, consistent with one or more exemplary embodiments of the present disclosure;

FIG. 2E illustrates a top view of a structural beam embraced by a beam gripping mechanism, consistent with one or more exemplary embodiments of the present disclosure;

FIG. 3A illustrates an exploded perspective view of a continuous track assembly, consistent with one or more exemplary embodiments of the present disclosure;

FIG. 3B illustrates an exploded side view of a continuous track assembly, consistent with one or more exemplary embodiments of the present disclosure;

FIG. 3C illustrates a sectional perspective view of a continuous track, consistent with one or more exemplary embodiments of the present disclosure;

FIG. 4 illustrates a perspective view of a beam lifting assembly, consistent with one or more exemplary embodiments of the present disclosure;

FIG. 5 illustrates a perspective view of a clamp, consistent with one or more exemplary embodiments of the present disclosure;

FIG. 6 illustrates a perspective view of a welding arm assembly, consistent with one or more exemplary embodiments of the present disclosure;

FIG. 7 illustrates a perspective view of a structure assembling robot mounted onto a building structure, consistent with one or more exemplary embodiments of the present disclosure;

FIG. 8A illustrates a perspective view of a structure assembling robot mounted on a structural beam, consistent with one or more exemplary embodiments of the present disclosure;

FIG. 8B illustrates a perspective view of a structure assembling robot mounting a second structural beam on a structural beam, consistent with one or more exemplary embodiments of the present disclosure;

FIG. 9A illustrates a perspective view of a structure assembling robot, consistent with one or more exemplary embodiments of the present disclosure; and

FIG. 9B illustrates a robotic beam grabbing mechanism, consistent with one or more exemplary embodiments of the present disclosure.

### DETAILED DESCRIPTION

The novel features which are believed to be characteristic of the present disclosure, as of its structure, organization, use and method of operation, together with further objectives and advantages thereof, will be better understood from the following discussion.

The present disclosure is directed to exemplary embodiments of a structure assembling robot that may be utilized for assembling and welding a building structure. An exemplary structural assembling robot may include beam gripping mechanisms that may allow for an exemplary robot to be mounted on structural beams of an exemplary beam structure and move along an exemplary building structure to access different parts of an exemplary building structure. An exemplary robot may further be equipped with beam lifting mechanisms that may function as cranes that may be utilized for lifting structural beams form a ground level or a storage area up to the position of an exemplary robot on an exemplary building structure. Then an exemplary lifted structural beam may be grabbed by an exemplary robot and may be positioned in a desired location on an exemplary building structure. Then an exemplary welding arm of an exemplary robot may be utilized for welding the lifted structural beam in the desired location. This way, exemplary structural beams may be lifted one by one by an exemplary robot and may be welded in a desired location on an exemplary building structure in a desired position with a desired orientation.

What follows is a description of exemplary embodiments of various mechanisms of an exemplary structural assembling robot that may allow the robot to be maneuvered on an exemplary building structure and lift and mount structural beams one by one on an exemplary building structure.

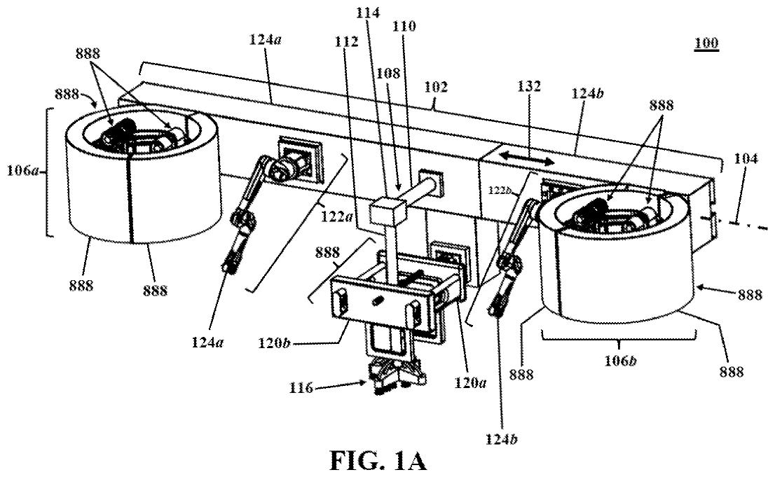

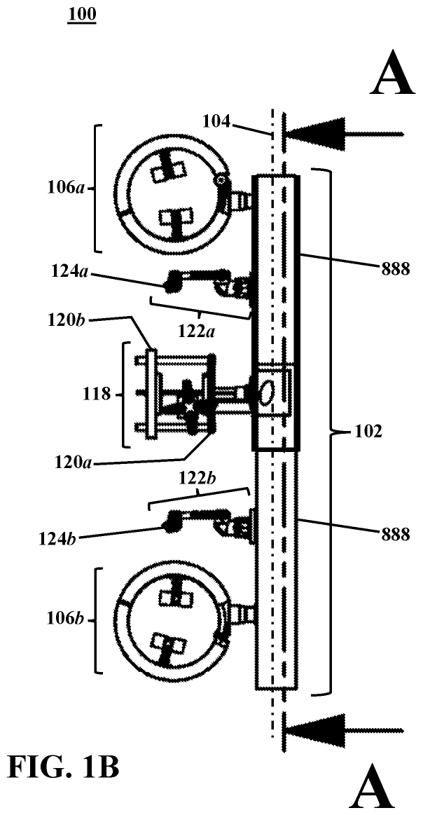

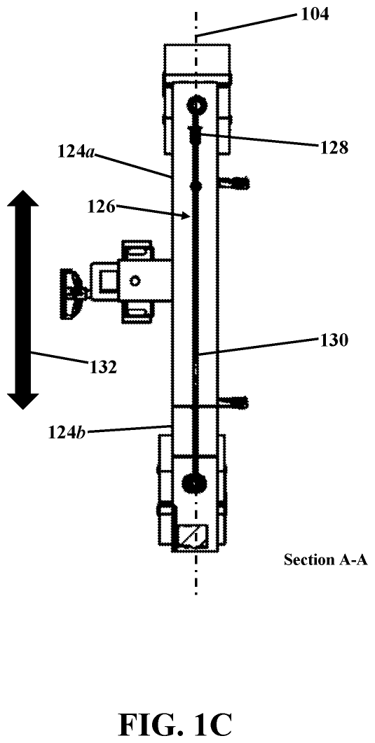

FIG. 1A illustrates a perspective view of a structure assembling robot 100, consistent with one or more exemplary embodiments of the present disclosure. FIG. 1B illustrates a top view of structure assembling robot 100, consistent with one or more exemplary embodiments of the present disclosure. FIG. 1C illustrates a sectional side view of structure assembling robot 100, consistent with one or more exemplary embodiments of the present disclosure.

In an exemplary embodiment, robot 100 may include an elongated telescopic bridge 102 that may function as a backbone of robot 100, on which various components and modules of robot 100 may be mounted. In an exemplary embodiment, a length of elongated telescopic bridge 102 may be adjustable along a longitudinal axis 104 of elongated telescopic bridge 102. In an exemplary embodiment, elongated telescopic bridge 102 may include at least two telescoping sections that may be configured to be telescopically slidable in each other, and thereby allow for adjusting the length of elongated telescopic bridge 102. For example, elongated telescopic bridge 102 may include an elongated base section 124a that may extend along longitudinal axis 104 and an elongated telescoping section 124b that may extend along longitudinal axis 104. In an exemplary embodiment, elongated telescoping section 124b may be configured to be moveably received within elongated base section 124a. In other words, elongated telescoping section 124b may be sized to slide in and out of elongated base section 124a along longitudinal axis 104 between a retracted position and an extended position. For example, elongated telescoping section 124b may be retracted by partially sliding elongated telescoping section 124b into elongated base section 124a and elongated telescoping section 124b may be extended by partially sliding elongated telescoping section 124b out of elongated base section 124a. To this end, elongated base section 124a may include an elongated hollow interior that may function as a sliding track for elongated telescoping section 124b to linearly slide in and out of elongated base section 124a along longitudinal axis 104.

In an exemplary embodiment, elongated telescopic bridge 102 may further include an actuating mechanism that may be coupled with the at least two telescoping sections of elongated telescopic bridge 102 and the actuating mechanism may be configured to actuate the linear sliding movements of the at least two telescoping sections of elongated telescopic bridge 102. For example, the actuating mechanism may include a linear actuator such as a ball-screw mechanism, or a linear hydraulic or electric jack. For example, elongated telescopic bridge 102 may include a linear actuating mechanism 126 that may be coupled between elongated base section 124a and elongated telescoping section 124b and may be configured to actuate a telescoping motion of elongated telescoping section 124b relative to elongated base section 124a. In an exemplary embodiment, linear actuating mechanism 126 may include a rotary actuator 128, such as an electric motor that may be coupled to a ball-screw mechanism 130. As used herein, linear actuating mechanism 126 being coupled between elongated base section 124a and elongated telescoping section 124b may refer to one end of linear actuating mechanism 126 being coupled to elongated base section 124a and the other opposing end of linear actuating mechanism 126 being coupled to elongated telescoping section 124b. For example, rotary actuator 128 may be attached to elongated base section 124a and a distal end of ball-screw mechanism 130 may be attached to elongated telescoping section 124b. In an exemplary embodiment, ball-screw mechanism 130 may transform the rotary motion of rotary actuator 128 into a linear translational motion of elongated telescoping section 124b. In an exemplary embodiment, rotary actuator 128 may be configured to drive the translational telescoping motion of elongated telescoping section 124b in and out of elongated base section 124a by utilizing ball-screw mechanism 130. In an exemplary embodiment, rotary actuator may be a standard rotating actuator driven when power is provided to it.

In an exemplary embodiment, other linear actuators may as well be utilized for driving the linear telescoping motion of elongated telescoping section 124b in and out of elongated base section 124a along longitudinal axis 104 in the direction shown by arrow 132. Such utilization of linear actuators, such as linear actuating mechanism 126 to drive the telescoping motion of the at least two telescoping sections of an exemplary elongated telescopic bridge of an exemplary structure assembling robot may allow for adjusting the length of an exemplary elongated telescopic bridge of an exemplary robot and thereby adapting the size of an exemplary robot based on the distances between exemplary beams of an exemplary structure to be assembled by an exemplary robot.

In an exemplary embodiment, robot 100 may further include at least one beam gripping mechanism that may be mounted on elongated telescopic bridge 102. As used herein, a beam may refer to a structural beam and the at least one beam gripping mechanism may be configured to embrace a beam and allow robot 100 to move along a beam, as will be described. For example, robot 100 may include a first beam gripping mechanism 106a that may be mounted on a first end of elongated telescopic bridge 102 and a second beam gripping mechanism 106b that may be mounted on an opposite second end of elongated bridge 102. In an exemplary embodiment, a distance between first beam gripping mechanism 106a and second beam gripping mechanism 106b along longitudinal axis 104 of elongated telescopic bridge 102 may be adjusted by adjusting the length of elongated telescopic bridge 102 along longitudinal axis 104. In an exemplary embodiment, first beam gripping mechanism 106a and second beam gripping mechanism 106b may be configured to embrace structural beams and allow for mounting robot 100 on a structure and moving robot 100 on the structure, as will be discussed.

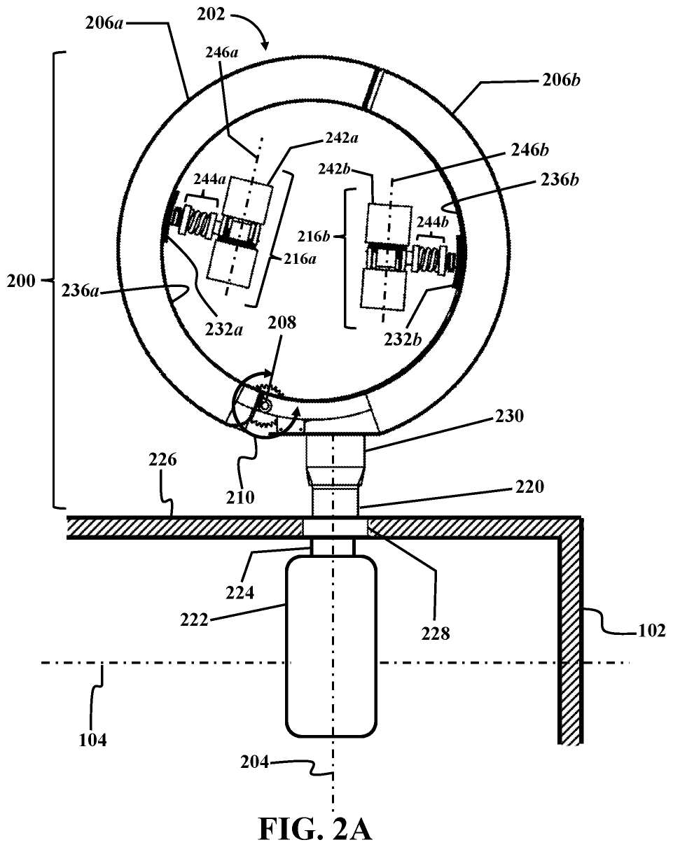

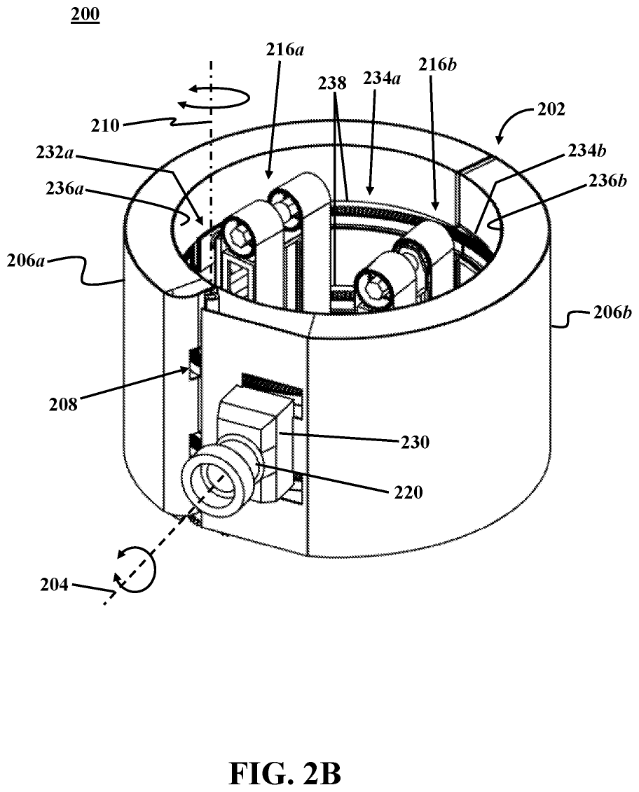

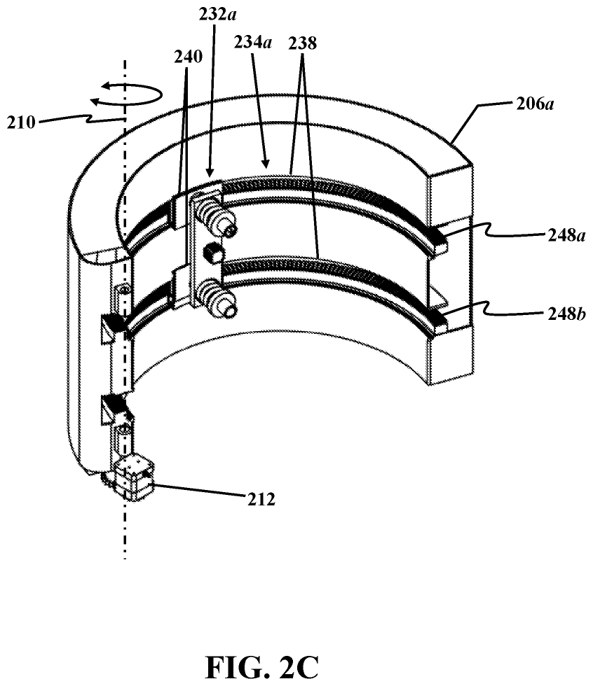

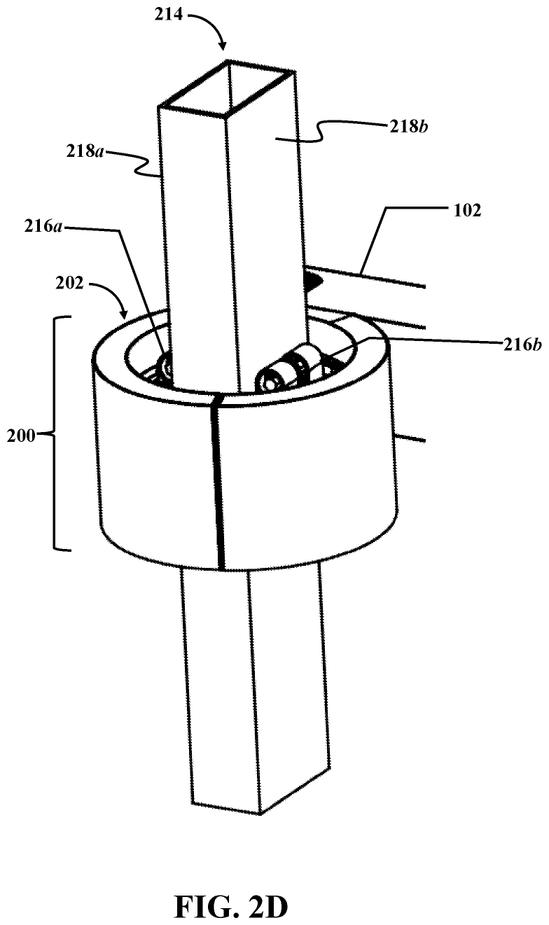

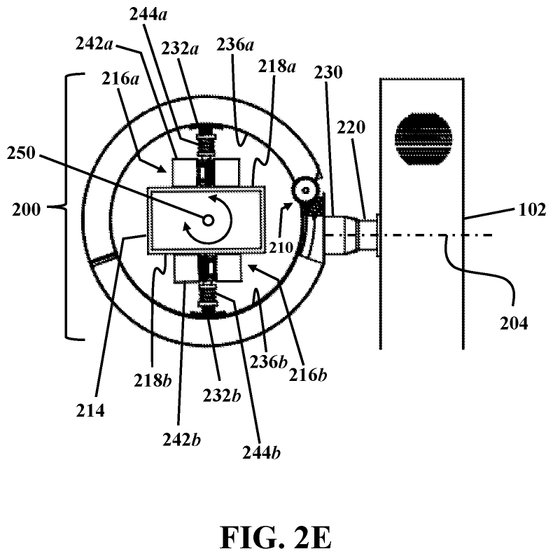

FIG. 2A illustrates a sectional top view of a beam gripping mechanism 200, consistent with one or more exemplary embodiments of the present disclosure. FIG. 2B illustrates a perspective view of beam gripping mechanism 200, consistent with one or more exemplary embodiments of the present disclosure. FIG. 2C illustrates a perspective view of a first curved section 206a of beam gripping mechanism 200, consistent with one or more exemplary embodiments of the present disclosure. FIG. 2D illustrates a perspective view of a structural beam embraced by beam gripping mechanism 200, consistent with one or more exemplary embodiments of the present disclosure. FIG. 2E illustrates a top view of a structural beam embraced by beam gripping mechanism 200, consistent with one or more exemplary embodiments of the present disclosure.

In an exemplary embodiment, beam gripping mechanism 200 may be structurally similar to first beam gripping mechanism 106a and second beam gripping mechanism 106b. In an exemplary embodiment, beam gripping mechanism 200 may include a main ring 202 that may be rotatably coupled to elongated telescopic bridge 102 to allow for main ring 202 to be rotatable about a rotational axis 204 perpendicular to longitudinal axis 104 of elongated telescopic bridge 102. In an exemplary embodiment, rotational axis 204 may be parallel with a circular cross-sectional plane of main ring 202. To this end, in an exemplary embodiment, beam gripping mechanism 200 may be coupled to elongated telescopic bridge 102 by utilizing a rotating shaft 220. In an exemplary embodiment, rotating shaft 220 may be coupled to a rotary actuator 222 that may be disposed within elongated telescopic bridge 102. For example, rotary actuator 222 may be mounted in a hollow interior of elongated telescopic bridge 102 and an output shaft 224 of rotary actuator 222 may extend through an outer wall 226 of elongated telescopic bridge 102 through an aperture 228 fitted with a bore bearing that may facilitate rotational motion of output shaft 224. In an exemplary embodiment, output shaft 224 may either be attached to rotating shaft 220 or may be integrally formed with rotating shaft 220. In an exemplary embodiment, rotating shaft 220 may be coupled to main ring 202 by utilizing a coupling member 230. In an exemplary embodiment, rotational movement of rotary actuator 222 may be transferred to main ring 202 via shafts (220, 224) or in other words, rotary actuator 222 may be configured to drive a rotational movement of main ring 202 about rotational axis 204 relative to elongated telescopic bridge 102.

In an exemplary embodiment, main ring 202 may include a first curved section 206a and a second curved section 206b that may be hinged to first curved section 206a by utilizing a hinge joint 208. In an exemplary embodiment, second curved section 206b and first curved section 206a may be configured to be pivotable relative to each other about a hinge axis 210 of hinge joint 208 that may be perpendicular to the circular cross-sectional plane of main ring 202. In an exemplary embodiment, hinge joint 208 may be coupled to a rotary hinge actuator 212 that may be an electric motor configured to drive a pivotal movement of at least one of first curved section 206a and second curved section 206b about hinge axis 210 of hinge joint 208. In an exemplary embodiment, such pivotal coupling of first curved section 206a and second curved section 206b of main ring 202 may allow for opening/closing main ring 202 similar to a claw. In other words, rotary hinge actuator 212 may be configured to drive a pivotal movement of first curved section 206a and second curved section 206b relative to each other and consequently may be configured to open/close main ring 202 such that a structural beam, such as beam 214 may be grabbed/released by utilizing main ring 202.

In an exemplary embodiment, beam gripping mechanism 200 may further include a first continuous track assembly 216a that may be disposed within main ring 202 and may be coupled to first curved section 206a and a second continuous track assembly 216b that may be disposed within main ring 202 and may be coupled to second curved section 206b. In an exemplary embodiment, first continuous track assembly 216a and second continuous track assembly 216b may be configured to engage opposing surfaces (218a, 218b) of an exemplary structural beam, such as beam 214 in response to beam 214 being received within main ring 202.

In an exemplary embodiment, first continuous track assembly 216a may include a first moving wagon 232a that may be moveably coupled to first curved section 206a of main ring 202 and second continuous track assembly 216b may include a second moving wagon 232b that may be moveably coupled to second curved section 206b of main ring 202. In an exemplary embodiment, first curved section 206a may further include a first recessed curved track portion 234a on an inner wall 236a of first curved section 206a, where first recessed curved track portion 234a may include a curved slit extending circumferentially on inner wall 236a of first curved section 206a. In an exemplary embodiment, second curved section 206b may further include a second recessed curved track portion 234b on an inner wall 236b of second curved section 206b, where second recessed curved track portion 234b may include a curved slit extending circumferentially on inner wall 236b of second curved section 206b.

Referring to FIG. 2C, in an exemplary embodiment, first recessed curved track portion 234a may include at least two curved slits 238 that may extend circumferentially on inner wall 236a, where two curved slits 238 may extend on parallel planes that are parallel to the circular cross-sectional plane of main ring 202. In an exemplary embodiment, first moving wagon 232a may include at least two sliders 240, where each slider of at least two sliders 240 may be coupled to a corresponding slit of at least two curved slits 238. In an exemplary embodiment, second recessed curved track portion 234b and second moving wagon 232b may be structurally similar to first recessed curved track portion 234a and first moving wagon 232a, respectively. Specifically, second recessed curved track portion 234b may include at least two curved slits that may extend circumferentially on inner wall 236b, where the two curved slits may extend on parallel planes that are parallel to the circular cross-sectional plane of main ring 202. In an exemplary embodiment, second moving wagon 232b may include at least two sliders, where each slider of the at least two sliders may be coupled to a corresponding slit of the at least two curved slits. The two parallel curved slits and the at least two corresponding sliders are not illustrated for simplicity.

In an exemplary embodiment, first continuous track assembly 216a may further include a first continuous track 242a that may be mounted on first moving wagon 232a by utilizing a first suspension mechanism 244a. In an exemplary embodiment, first suspension mechanism 244a may include at least one elastic member that may be mounted between first continuous track 242a and first moving wagon 232a. In an exemplary embodiment, first suspension mechanism 244a may allow for maintaining the contact between first continuous track 242a and an outer surface a structural beam in response to a structural beam having been received between first continuous track assembly 216a and second continuous track assembly 216b. Furthermore, in an exemplary embodiment, first suspension mechanism 244a may be configured to provide first continuous track 242a with an additional pitch degree of freedom about a first pitch axis 246a.

In an exemplary embodiment, second continuous track assembly 216b may further include a second continuous track 242b that may be mounted on second moving wagon 232b by utilizing a second suspension mechanism 244b. In an exemplary embodiment, second suspension mechanism 244b may include at least one elastic member that may be mounted between second continuous track 242b and second moving wagon 232b. In an exemplary embodiment, second suspension mechanism 244b may be configured to maintain the contact between second continuous track 242b and an outer surface a structural beam in response to a structural beam having been received between first continuous track assembly 216a and second continuous track assembly 216b. Furthermore, in an exemplary embodiment, second suspension mechanism 244b may be configured to provide second continuous track 242b with an additional pitch degree of freedom about a second pitch axis 246b.

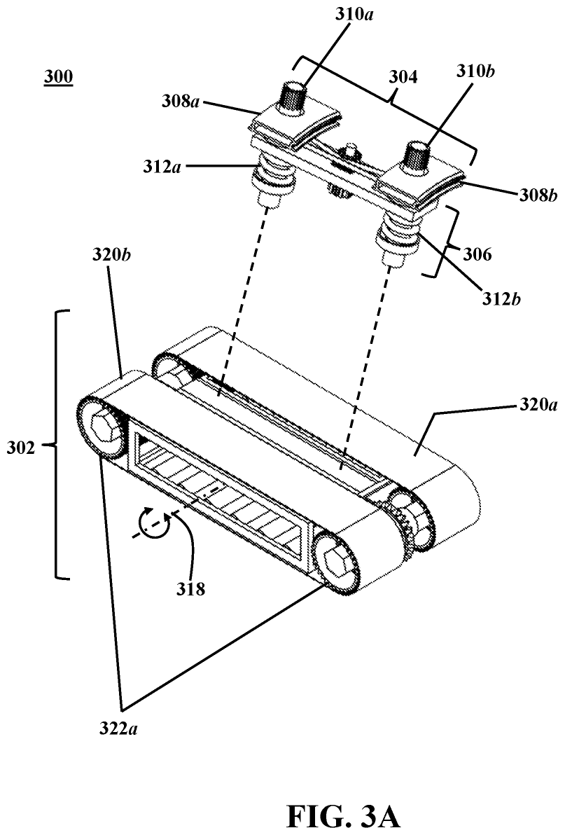

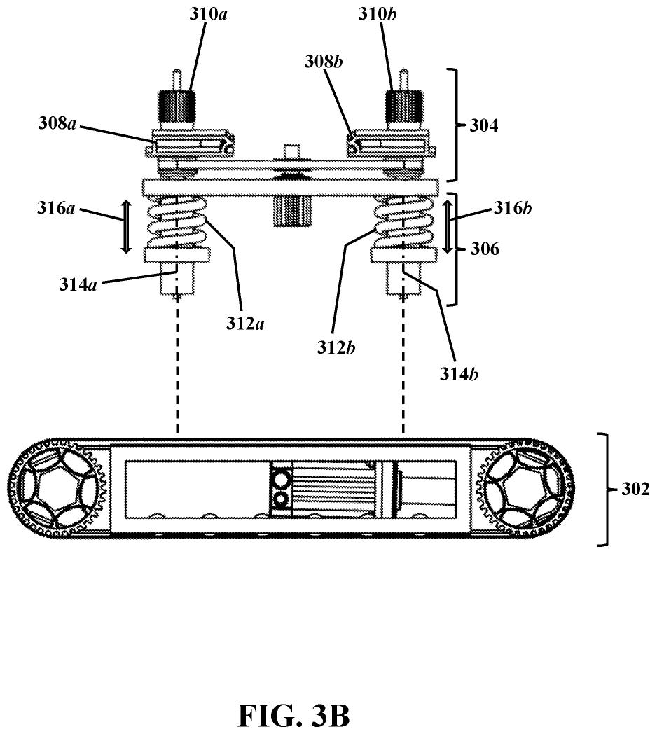

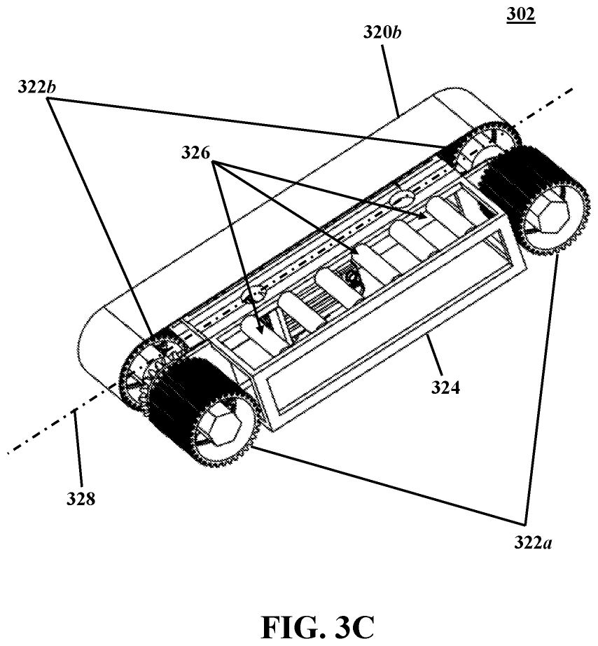

FIG. 3A illustrates an exploded perspective view of a continuous track assembly 300, consistent with one or more exemplary embodiments of the present disclosure. FIG. 3B illustrates an exploded side view of continuous track assembly 300, consistent with one or more exemplary embodiments of the present disclosure. FIG. 3C illustrates a sectional perspective view of continuous track 302, consistent with one or more exemplary embodiments of the present disclosure.

In an exemplary embodiment, continuous track assembly 300 may be structurally similar to first continuous track assembly 216a and second continuous track assembly 216b. In an exemplary embodiment, continuous track assembly 300 may include a continuous track 302 similar to first and second continuous tracks (242a and 242b) that may be mounted on a moving wagon 304 similar to first and second moving wagons (232a and 232b) by utilizing a suspension mechanism 306 similar to first and second suspension mechanisms (244a and 244b).

In an exemplary embodiment, moving wagon 304 may include at least two sliders (308a, 308b) similar to at least two sliders 240 of first moving wagon 232a. In an exemplary embodiment, each slider of at least two sliders (308a, 308b) may include a respective motorized pinion. For example, slider 308a may include motorized pinion 310a and slider 308b may include motorized pinion 310b. Referring to FIG. 2C, in an exemplary embodiment, first recessed curved track portion 234a on inner wall 236a of first curved section 206a and second recessed curved track portion 234b on inner wall 236b of second curved section 206a may each be fitted with a respective rack. For example, at least two curved slits 238 of first recessed curved track portion 234a may each be fitted with a respective rack, such as racks (248a, 248b). In an exemplary embodiment, motorized pinion 310a of slider 308a may mesh with rack 248a and motorized pinion 310b of slider 308b may mesh with rack 248b and this way moving wagon 304 may be moveably coupled to a corresponding recessed curved track portion.

In an exemplary embodiment, such coupling of first continuous track assembly 216a and second continuous track assembly 216b to corresponding first recessed curved track portion 234a and second recessed curved track portion 234b by utilizing rack-and-pinion coupling mechanism as described in the previous paragraph, may provide a respective rotational degree of freedom for each continuous track assembly of first continuous track assembly 216a and second continuous track assembly 216b about a normal axis 250 of main ring 202. In other words, first continuous track assembly 216a and second continuous track assembly 216b may be rotatable about normal axis 250 of main ring 202.

In an exemplary embodiment, suspension mechanism 306 may include a first elastic member 312a and a second elastic member 312b that may comprise two springs, two hydraulic jacks, or a combination of springs and hydraulic jacks. In an exemplary embodiment, first elastic member 312a and a second elastic member 312b may be either compressible or retractable/extendable along their respective longitudinal axes (314a, 314b) along directions shown by arrows (316a, 316b). In an exemplary embodiment, such compression/expansion or extension/retraction of first elastic member 312a and second elastic member 312b may provide continuous track 302 with a pitch degree n of freedom about a pitch axis 318. Such pitch degree of freedom was previously discussed with respect to first and second continuous tracks (242a, 242b) that may be structurally similar to continuous track assembly 302. In an exemplary embodiment, pitch degree of freedom of continuous track 302 about pitch axis 318 may be similar to pitch degree of freedom of first continuous track assembly 242a about first pitch axis 246a and may be similar to pitch degree of freedom of second continuous track assembly 242b about second pitch axis 246b.

In an exemplary embodiment, each continuous track may include a continuous track similar to continuous tracks that are commonly used in tanks or loaders. For example, an exemplary continuous track similar to continuous track 302 may include two parallel belts (320a, 320b) that may be mounted around a couple of respective wheels (322a, 322b) that may allow for continuously rotating parallel belts (320a, 320b) about respective wheels (322a, 322b). In an exemplary embodiment, continuous track 302 may include a solid frame 324 on which wheels (322a, 322b) may be mounted. In an exemplary embodiment, solid frame 324 may further include a plurality of rollers, such as rollers 326 that may be mounted between wheels (322a, 322b) along a longitudinal axis 328 of continuous track 302. Rollers 326 may allow for each belt to move smoothly thereon without each belt being bent or deformed.

In an exemplary embodiment, robot 100 may further include a beam lifting assembly 108 that may be configured to function as a crane that may be utilized for grabbing and lifting structural beams. In an exemplary embodiment, beam lifting assembly 108 may be a cable-operated lift, in which a cable connected to an end-effector may be actuated by a cable actuating mechanism, such as a motorized pulley. An exemplary end-effector may be a mechanical, suction, or magnetic end-effector that may be configured to engage or grab a structural beam. An exemplary cable actuating mechanism may allow for winding or unwinding an exemplary cable to lift or lower an exemplary beam engaged with an exemplary end-effector of beam lifting assembly 108. For example, beam lifting assembly 108 may include a main pole 110 that may be attached to elongated telescopic bridge 102, a cable 112, a cable actuating mechanism 114 that may be coupled to a distal end of main pole 110, and an end-effector 116 that may be attached to a distal end of cable 112. In practice, when robot 100 is mounted on a structure, beam lifting assembly 108 may be utilized for lifting beams up to a desired position, where robot 100 is located to allow for installing and welding beams in the desired position with a desired orientation.

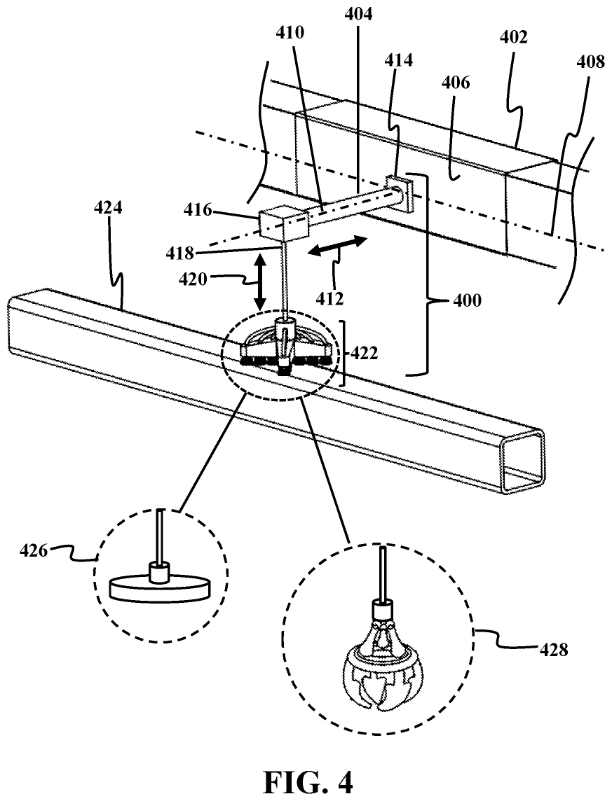

FIG. 4 illustrates a perspective view of a beam lifting assembly 400, consistent with one or more exemplary embodiments of the present disclosure. In an exemplary embodiment, beam lifting assembly 400 may be structurally similar to beam lifting assembly 108 and may be attached to an elongated telescopic bridge 402 similar to elongated telescopic bridge 102. In an exemplary embodiment, beam lifting assembly 400 may include a main pole 404 similar to main pole 110 that may extend from an outer wall 406 of elongated telescopic bridge 402 along an axis perpendicular to a longitudinal axis 408 of elongated telescopic bridge 402. In other words, a longitudinal axis 410 of main pole 404 may be perpendicular to longitudinal axis 408 of elongated telescopic bridge 402. In an exemplary embodiment, main pole 404 may be configured to be extendable/retractable along longitudinal axis 410 of main pole 404 in directions shown by arrow 412. In an exemplary embodiment, a proximal end of main pole 404 may be fixedly attached to outer wall 406 by utilizing a fixed attachment member 414.

In an exemplary embodiment, beam lifting assembly 400 may further include a cable actuating mechanism 416 similar to cable actuating mechanism 114 that may be mounted on a distal end of main pole 404. In an exemplary embodiment, cable actuating mechanism 114 may include a winch or a motorized pulley that may allow for winding and unwinding a cable 418 similar to cable 112 and thereby pull cable 418 up or release cable 418 to move down in directions substantially illustrated by an arrow 420. In an exemplary embodiment, cable actuating mechanism 114 may allow for winding or unwinding cable 418 along a substantially vertical direction to allow for beam lifting assembly 400 to lift or lower structural beams along a vertical direction as shown by arrow 420.

In an exemplary embodiment, beam lifting assembly 400 may further include an end-effector 422 similar to end-effector 116 that may be coupled to a distal end of cable 418. In an exemplary embodiment, end-effector 422 may be configured to engage a structural beam, such as structural beam 424. As used herein, end-effector 422 being engaged with a structural beam may refer to end-effector 422 grabbing or grasping a structural beam to allow for beam lifting assembly 400 to lift or lower the structural beam. In an exemplary embodiment, end-effector 422 may be a suction-cup end-effector, where the gripping force is provided by a plurality of suction cups that may be engaged with an outer surface of a structural beam. In an exemplary embodiment, end-effector 422 may be a magnetic end-effector as illustrated in inset 426, where a magnetic member may be magnetically attached to an exemplary structural beam, such as structural beam 424. In an exemplary embodiment, end-effector 422 may be a mechanical claw as illustrated in inset 428, where a mechanical claw may grab an exemplary structural beam, such as structural beam 424.

In an exemplary embodiment, robot 100 may further include a clamp 118 that may be mounted on elongated telescopic bridge 102 and may be configured to grab an exemplary structural beam lifted by beam lifting assembly 108 and fix an exemplary beam in a desired position and orientation for installation. In an exemplary embodiment, clamp 118 may include a fixed jaw 120a and a moveable jaw 120b that may be coupled to fixed jaw 120a. In an exemplary embodiment, clamp 118 may allow for grabbing or releasing a beam disposed between fixed jaw 120a and moveable jaw 120b by moving moveable jaw 120b relative to fixed jaw 120a.

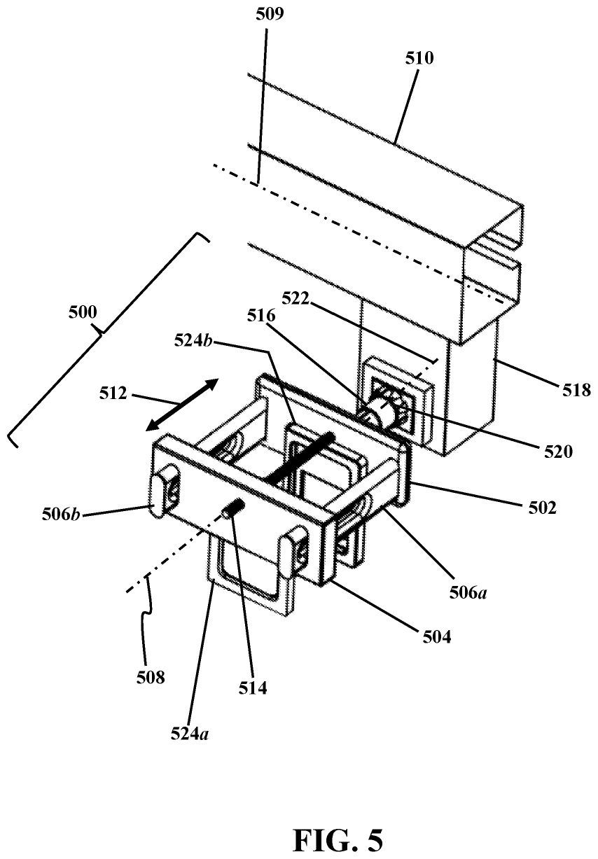

FIG. 5 illustrates a perspective view of a clamp 500, consistent with one or more exemplary embodiments of the present disclosure. In an exemplary embodiment, clamp 500 may be structurally similar to clamp 118 and may be configured to grab an exemplary structural beam lifted by an exemplary beam lifting assembly, such as beam lifting assembly 108 or beam lifting assembly 400 and fix an exemplary beam in a desired position and orientation for installation. In an exemplary embodiment, clamp 500 may include a fixed jaw 502 similar to fixed jaw 120a and a moveable jaw 504 similar to moveable jaw 120b. In an exemplary embodiment, clamp 500 may further include a couple of sliding guide links (506a, 506b) that may extend out of fixed jaw 502 along a sliding axis 508 perpendicular to a longitudinal axis 509 of an elongated telescopic bridge 510 similar to elongated telescopic bridge 102. In an exemplary embodiment, moveable jaw 504 may be slidably coupled with sliding guide links (506a, 506b) on respective sides of moveable jaw 504, such that moveable jaw 504 may be slidable along sliding guide links (506a, 506b) toward and away from fixed jaw 502 along sliding axis 508 in directions illustrated by an arrow 512.

In an exemplary embodiment, clamp 500 may further include a linear actuating mechanism that may be coupled between fixed jaw 502 and moveable jaw 504, where an exemplary linear actuator may be configured to drive a sliding movement of moveable jaw 504 along sliding axis 508 in directions illustrated by an arrow 512. For example, clamp 500 may further include a ball-screw mechanism 514 that may be coupled between fixed jaw 502 and moveable jaw 504, where ball-screw mechanism 514 may be configured to drive a sliding movement of moveable jaw 504 along sliding axis 508 in directions illustrated by an arrow 512.

In an exemplary embodiment, clamp 500 may further be rotatably coupled to elongated telescopic bridge 510 by utilizing a rotatable shaft 516 that may be rotatably coupled to an extension link 518 attached to elongated telescopic bridge 510. In an exemplary embodiment, rotatable shaft 516 may be coupled to a rotary actuator (not illustrated) that may be disposed within the hollow interior of extension link 518. To this end, rotatable shaft 516 may pass through an aperture on an outer wall of extension link 518, where the aperture may be fitted with a bore bearing 520 to facilitate rotation of rotatable shaft 516 about a longitudinal axis 522 of rotatable shaft 516. In an exemplary embodiment, extension link 518 may include an elongated hollow link extending along an axis perpendicular to both longitudinal axis 509 and longitudinal axis 522. In an exemplary embodiment, such rotatable coupling of clamp 500 to elongated telescopic bridge 510 may provide clamp 500 with a roll degree of freedom about longitudinal axis 522 of rotatable shaft 516.

In an exemplary embodiment, clamp 500 may further include two jaw extensions (524a, 524b) that may be respectively attached to fixed jaw 502 and moveable jaw 504. In an exemplary embodiment, two jaw extensions (524a, 524b) may include two parallel links extending perpendicular to sliding axis 508. In an exemplary embodiment, include two jaw extensions (524a, 524b) may be configured to engage opposing surfaces of a structural beam in response to the structural beam having been lifted up to a position between fixed jaw 502 and moveable jaw 504. Simply put, clamp 500 may be configured to hold a structural beam in a desired position and orientation. To this end, moveable jaw 504 and its corresponding jaw extension 524a may slide along sliding axis 508 to tightly grab a structural beam. As used herein, tightly grab may refer to an exemplary structural beam not having any unwanted translational or rotational movement with respect to clamp 500 responsive to an exemplary structural beam being grabbed by clamp 500. Furthermore, as mentioned before, rotatable coupling of clamp 500 to elongated telescopic bridge 510 may allow for adjusting the orientation of an exemplary structural beam utilizing the roll degree of freedom about longitudinal axis 522.

In an exemplary embodiment, robot 100 may further include at least one welding arm assembly that may serve as a robotic arm with multiple degrees of freedom to allow for performing precise welds on exemplary structural beams. For example, robot 100 may include a first welding arm assembly 122a and a second welding arm assembly 122b that may be mounted on opposite ends of elongated telescopic bridge 102 along longitudinal axis 104. In an exemplary embodiment, each exemplary welding arm assembly may be equipped with a welding end-effector that may be mounted on a distal end of a robotic arm of each exemplary welding arm assembly. For example, first welding arm assembly 122a may be equipped with a first welding end-effector 124a and second welding arm assembly 122b may be equipped with a second welding end-effector 124b.

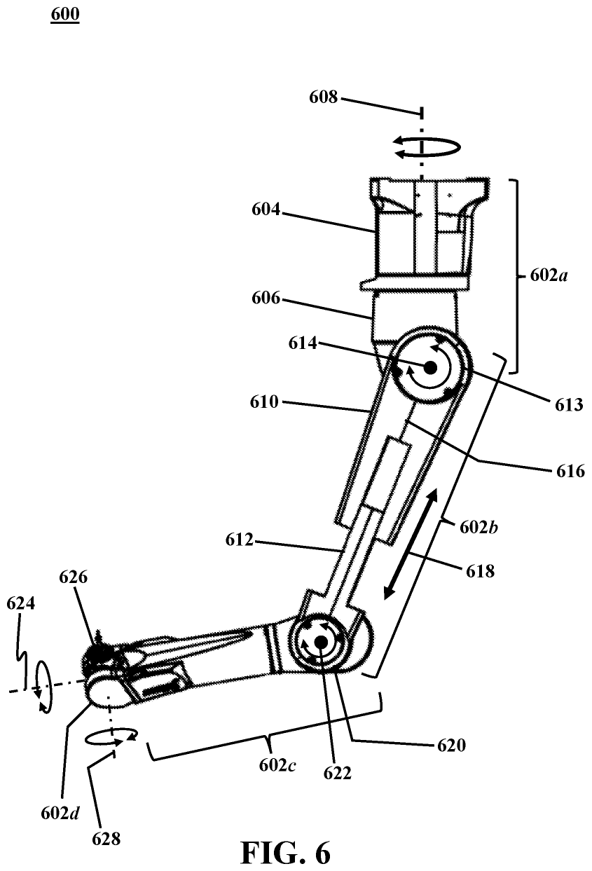

FIG. 6 illustrates a perspective view of a welding arm assembly 600, consistent with one or more exemplary embodiments of the present disclosure. In an exemplary embodiment, welding arm assembly 600 may be structurally similar to first welding arm assembly 122a and second welding arm assembly 122b. In an exemplary embodiment, welding arm assembly may include four arm sections (602a-602d) that may be rotatably coupled to each other.

In an exemplary embodiment, first arm section 602a may include a first arm segment 604 that may be fixedly mounted on an exemplary elongated telescopic bridge, such as elongated telescopic bridge 102. In an exemplary embodiment, first arm section 602a may further include a rotatable segment 606 that may be rotatably coupled to first arm segment 604 and may be rotatable with respect to first arm segment 604 about a longitudinal axis 608 of first arm segment 604. In an exemplary embodiment, longitudinal axis 608 of first arm segment 604 may be perpendicular to longitudinal axis 104 of elongated telescopic bridge 102. In an exemplary embodiment, such rotational coupling of rotatable segment 606 and first arm segment 604 may provide a roll degree of freedom for welding arm assembly 600 about longitudinal axis of first arm segment 604.

In an exemplary embodiment, second arm section 602b may include a second arm segment 610 and a sliding arm segment 612 that may be slidably or telescopically coupled to second arm segment 610. In an exemplary embodiment, second arm segment 610 may be rotatably coupled to rotatable segment 606 by utilizing a single-axis joint 613 that may allow for a rotational movement of second arm segment 610 with respect to rotatable segment 606 about a first rotational axis 614. In an exemplary embodiment, sliding arm segment 612 may be rotatable with second arm segment 610 about first rotational axis 614. In an exemplary embodiment, sliding arm segment 612 may be slidably moveable along a longitudinal axis 616 of second arm segment 610 in directions shown by arrow 618. In an exemplary embodiment, such linear movement of sliding arm segment 612 relative to second arm segment 610 may provide a linear translational degree of freedom for welding arm assembly 600. In other words, such linear movement of sliding arm segment 612 relative to second arm segment 610 may make second arm section 602b an adjustable arm section, a length of which may change on demand.

In an exemplary embodiment, third arm section 602c may be rotatably coupled to sliding arm segment 612 by utilizing a single-axis joint 620 that may allow for rotational movement of third arm section 602c relative to sliding arm segment 612 about a second rotational axis 622. Such rotational coupling of third arm section 602c and sliding arm segment 612 may provide another rotational degree of freedom for welding arm assembly 600.

In an exemplary embodiment, fourth arm section 602d may include an end-effector adapter that may be rotatably coupled to third arm section 602c. In an exemplary embodiment, fourth arm section 602d may be rotatable about a longitudinal axis 624 of third arm section 602c providing another rotational degree of freedom for welding arm assembly 600.

In an exemplary embodiment, welding arm assembly 600 may further include a welding end-effector 626 that may be rotatably coupled to fourth arm section 602d. Such rotatable coupling of welding end-effector 626 and fourth arm section 602d may allow for rotating welding end-effector 626 about a third rotational axis 628 which is perpendicular to longitudinal axis 624 of third arm section 602c.

In an exemplary embodiment, as discussed in preceding paragraphs, welding arm assembly 600 may include five rotational degrees of freedom and a translational degree of freedom that may allow for an efficient and precise maneuvering of welding end-effector 626. Such precise maneuverability of welding end-effector 626 may allow for welding structural beams at different positions and orientations.

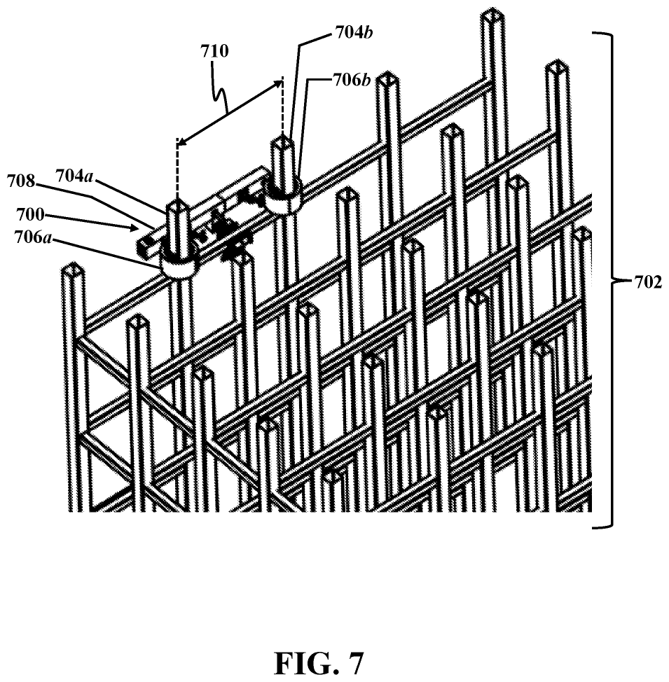

FIG. 7 illustrates a perspective view of a structure assembling robot 700 mounted onto a building structure 702, consistent with one or more exemplary embodiments of the present disclosure. In an exemplary embodiment, structure assembling robot 700 may be similar to structure assembling robot 100 and may be configured to move on building structure 702 and assemble structural beams on various parts of building structure 702 with desired orientations. In an exemplary embodiment, structure assembling robot 700 may include a first beam gripping assembly 706a similar to first beam gripping assembly 106a and a second beam gripping assembly 706b similar to second beam gripping assembly 106b. In practice, first beam gripping assembly 706a and second beam gripping assembly 706b may be configured to allow for mounting structure assembling robot 700 between structural beams of building structure 702. For example, first beam gripping assembly 706a may be configured to be mounted on a first vertical beam 704a of building structure 702 and second beam gripping assembly 706b may be configured to be mounted on a second vertical beam 704b of building structure 702.

In an exemplary embodiment, structure assembling robot 700 may further include an elongated telescopic bridge 708 similar to elongated telescopic bridge 102 that may allow for changing the distance between first beam gripping assembly 706a and second beam gripping assembly 706b to allow for mounting structure assembling robot 700 between structural beams of building structure 702 with different distances between the structural beams. For example, elongated telescopic bridge 708 may be adjusted to be adapted with a distance 710 between first vertical beam 704a and second vertical beam 704b. In practice, when structure assembling robot 700 is mounted in the desired position or moved to the desired position, by utilizing beam lifting assembly of structure assembling robot 700 structural beams may be lifted from ground up to the position of structure assembling robot 700 and an exemplary clamp of structure assembling robot 700 may fix the lifted structural beam in position for welding arm assembly of structure assembling robot 700 to weld the structural beam in a desired location on building structure 702. For simplicity, beam lifting assembly, clamp, and welding arm assembly of structure assembling robot 700 are not labeled in FIG. 7.

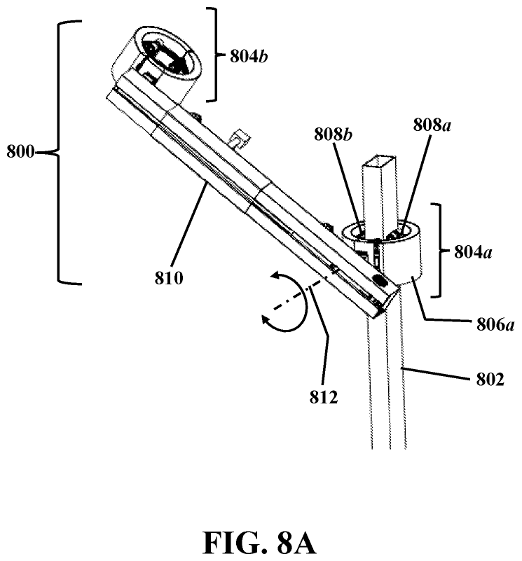

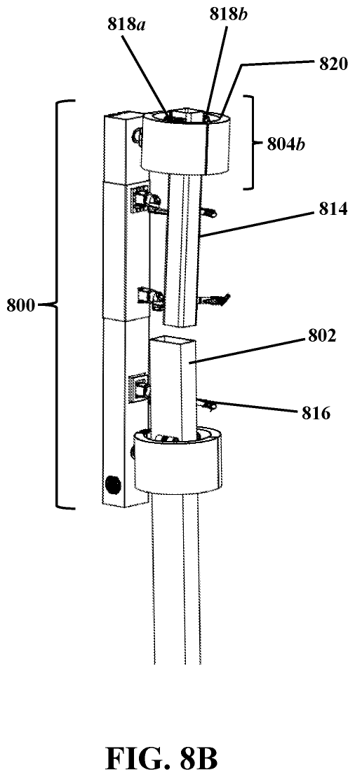

FIG. 8A illustrates a perspective view of a structure assembling robot 800 mounted on a structural beam 802, consistent with one or more exemplary embodiments of the present disclosure. In an exemplary embodiment, structure assembling robot 800 may be similar to structure assembling robot 100 and may include a first beam gripping assembly 804a similar to first beam gripping assembly 106a and a second beam gripping assembly 804b similar to second beam gripping assembly 106b.

FIG. 8A illustrates how degrees of freedom of an exemplary beam gripping assembly of an exemplary structural assembling robot may be utilized for maneuvering an exemplary robot on an exemplary building structure. For example, structure assembling robot 800 may be mounted on structural beam 802 by utilizing first beam gripping assembly 804a. To this end, a first main ring 806a of first beam gripping assembly 804a that may be structurally similar to main ring 202 may embrace structural beam 802 such that opposite surfaces of structural beam 802 may be positioned between a first continuous track assembly 808a and a second continuous track assembly 808b of first main ring 806a. In an exemplary embodiment, first and second continuous track assemblies (808a, 808b) may be structurally similar to first and second continuous track assemblies (216a, 216b). In practice, to change the orientation of structure assembling robot 800 from a horizontal position between two vertical structural beams to a vertical orientation, second beam gripping assembly 804b may release the structural beam on which it was mounted on and first main ring 806a of first beam gripping assembly 804a may be utilized for rotating structure assembling robot 800 about an axis perpendicular to a longitudinal axis of structural beam 802. In an exemplary embodiment, first main ring 806a may be rotatably mounted on an elongated telescopic bridge 810 of structure assembling robot 800 similar to main ring 202 that may be rotatably mounted to elongated telescopic bridge 102. In an exemplary embodiment, first main ring 806a may be rotatable about a first rotational axis 812 perpendicular to the longitudinal axis of elongated telescopic bridge 810, which may allow for rotating structure assembling robot 800 about first rotational axis 812 relative to structural beam 802.

FIG. 8B illustrates a perspective view of structure assembling robot 800 mounting a second structural beam 814 on structural beam 802, consistent with one or more exemplary embodiments of the present disclosure. In practice, when an exemplary beam lifting assembly of structure assembling robot 800 lifts an exemplary structural beam, such as second structural beam 814 from the ground level up to the position of structure assembling robot 800, second beam gripping assembly 804b may be utilized for gripping second structural beam 814 and adjusting the position and orientation of second structural beam 814 over structural beam 802, for a welding arm assembly 816 of structure assembling robot 800 to weld second structural beam 814 on structural beam 802. To this end, first and second continuous track assemblies (818a, 818b) of second beam gripping assembly 804b may be utilized for adjusting a vertical position of second structural beam 814 relative to structural beam 802 and rotational degree of freedom of second main ring 820 of second beam gripping assembly 804b may be utilized for adjusting the orientation of second structural beam 814 relative to structural beam 802.

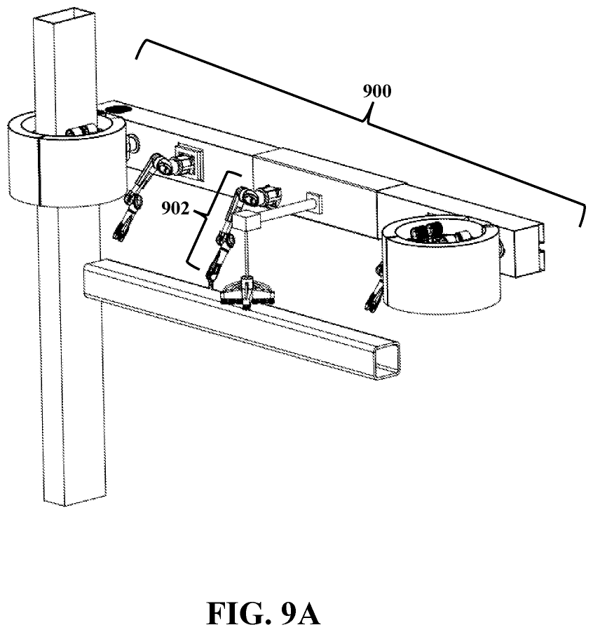

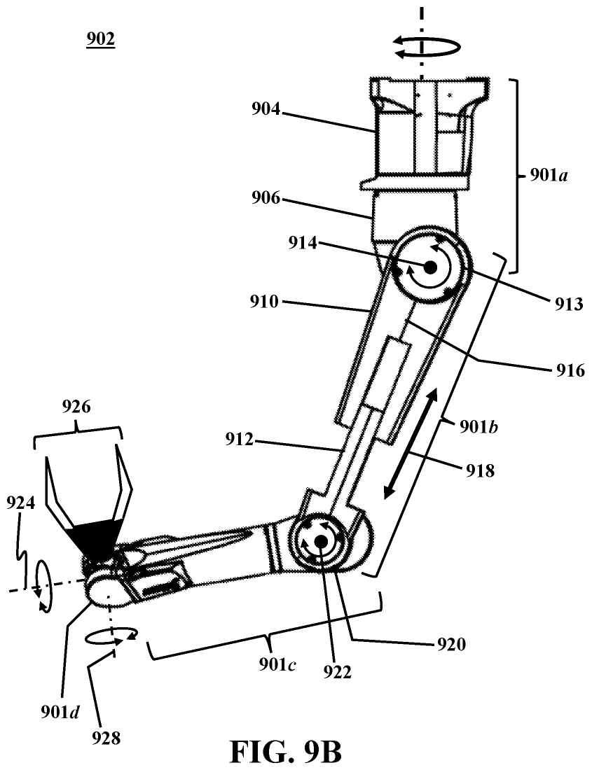

FIG. 9A illustrates a perspective view of a structure assembling robot 900, consistent with one or more exemplary embodiments of the present disclosure. FIG. 9B illustrates a robotic beam grabbing mechanism 902, consistent with one or more exemplary embodiments of the present disclosure. In an exemplary embodiment, structure assembling robot 900 may be similar to structure assembling robot 100, however, instead of an exemplary clamp similar to clamp 118 that may be configured to grab and fix an exemplary structural beam in desired position and orientation, here an exemplary robotic beam grabbing mechanism, such as robotic beam grabbing mechanism 902 may be configured to grab and fix an exemplary structural beam in desired position and orientation.

Referring to FIG. 9B, in an exemplary embodiment, robotic beam grabbing mechanism 902 may include four arm sections (901a-901d) that may be rotatably coupled to each other. In an exemplary embodiment, first arm section 901a may include a first arm segment 904 that may be fixedly mounted on an exemplary elongated telescopic bridge, such as elongated telescopic bridge 102. In an exemplary embodiment, first arm section 901a may further include a rotatable segment 906 that may be rotatably coupled to first arm segment 904 and may be rotatable with respect to first arm segment 904 about a longitudinal axis 908 of first arm segment 904. In an exemplary embodiment, longitudinal axis 908 of first arm segment 904 may be perpendicular to longitudinal axis 104 of elongated telescopic bridge 102. In an exemplary embodiment, such rotational coupling of rotatable segment 906 and first arm segment 904 may provide a roll degree of freedom for robotic beam grabbing mechanism 902 about longitudinal axis of first arm segment 904.

In an exemplary embodiment, second arm section 901b may include a second arm segment 910 and a sliding arm segment 912 that may be slidably or telescopically coupled to second arm segment 910. In an exemplary embodiment, second arm segment 910 may be rotatably coupled to rotatable segment 906 by utilizing a single-axis joint 913 that may allow for a rotational movement of second arm segment 910 with respect to rotatable segment 906 about a first rotational axis 914. In an exemplary embodiment, sliding arm segment 912 may be rotatable with second arm segment 910 about first rotational axis 914. In an exemplary embodiment, sliding arm segment 912 may be slidably moveable along a longitudinal axis 916 of second arm segment 910 in directions shown by arrow 918. In an exemplary embodiment, such linear movement of sliding arm segment 912 relative to second arm segment 910 may provide a linear translational degree of freedom for robotic beam grabbing mechanism 902. In other words, such linear movement of sliding arm segment 912 relative to second arm segment 910 may make second arm section 901b an adjustable arm section, a length of which may change on demand.

In an exemplary embodiment, third arm section 901c may be rotatably coupled to sliding arm segment 912 by utilizing a single-axis joint 920 that may allow for rotational movement of third arm section 901c relative to sliding arm segment 912 about a second rotational axis 922. Such rotational coupling of third arm section 901c and sliding arm segment 912 may provide another rotational degree of freedom for robotic beam grabbing mechanism 902.

In an exemplary embodiment, fourth arm section 901d may include an end-effector adapter that may be rotatably coupled to third arm section 901c. In an exemplary embodiment, fourth arm section 901d may be rotatable about a longitudinal axis 924 of third arm section 602c providing another rotational degree of freedom for robotic beam grabbing mechanism 902.

In an exemplary embodiment, robotic beam grabbing mechanism 902 may further include a grasping end-effector 926 that may be rotatably coupled to fourth arm section 901d. Such rotatable coupling of grasping end-effector 926 and fourth arm section 901d may allow for rotating grasping end-effector 926 about a third rotational axis 928 which is perpendicular to longitudinal axis 924 of third arm section 901c.

In an exemplary embodiment, as discussed in preceding paragraphs, robotic beam grabbing mechanism 902 may include five rotational degrees of freedom and a translational degree of freedom that may allow for an efficient and precise maneuvering of grasping end-effector 926. Such precise maneuverability of grasping end-effector 926 may allow for grabbing and positioning of structural beams at different positions and orientations.

In exemplary embodiments, such movement mechanism of an exemplary structure assembling robot may allow an exemplary structure assembling robot to move only between two beams of an exemplary building structure. Consequently, the size of an exemplary structure assembling robot may depend only on a distance between two adjacent beams. Therefore, the size of an exemplary structure assembling robot is almost independent on the size of the entire building structure. Such independence of an exemplary structure assembling robot of the size of the structure to be assembled may allow for utilizing a single robot for assembling various structures with different shapes and sizes.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A structure assembling robot, comprising:
an elongated telescopic bridge with an adjustable length along a longitudinal axis of the elongated telescopic bridge, the elongated telescopic bridge comprising:
an elongated base section extending along the longitudinal axis of the elongated telescopic bridge;
an elongated telescoping section extending along the longitudinal axis of the elongated telescopic bridge, the elongated telescoping section telescopically received within the elongated base section, the elongated telescoping section configured to be linearly extended/retracted relative to the elongated base section along the longitudinal axis of the elongated telescopic bridge; and
a linear actuator coupled between the elongated base section and the elongated telescoping section, the linear actuator configured to linearly extend/retract the elongated telescoping section relative to the elongated base section along the longitudinal axis of the elongated telescopic bridge;
at least one beam gripping mechanism mounted on the elongated telescopic bridge, the at least one beam gripping mechanism comprising:
a main ring rotatably coupled to the elongated telescopic bridge, the main ring configured to be rotatable about a rotational axis perpendicular to the longitudinal axis of the elongated telescopic bridge, the rotational axis parallel with a circular cross-sectional plane of the main ring, the main ring comprising:
a first curved section comprising a first recessed curved track portion extending circumferentially on an inner wall of the first curved section, the first continuous track assembly moveably coupled to the first recessed curved track portion;
a second curved section hinged to the first curved section, the second curved section and the first curved section configured to be pivotable relative to each other about a hinge axis perpendicular to the circular cross-sectional plane of the main ring, the second curved section comprising a second recessed curved track portion extending circumferentially on an inner wall of the second curved section, the second continuous track assembly moveably coupled to the second recessed curved track portion;
a rotatable shaft attached to the main ring from a first end of the rotatable shaft, the main ring rotatable with the rotatable shaft about the longitudinal axis of the rotatable shaft, a longitudinal axis of the rotatable shaft perpendicular to the longitudinal axis of the elongated telescopic bridge and parallel with the rotational axis of the main ring, an opposing second end of the rotatable shaft rotatably coupled to the elongated telescopic bridge, the second end of the rotatable shaft being further coupled to a rotary actuator disposed within the elongated telescopic bridge, the rotary actuator configured to drive a rotational movement of the rotatable shaft; and
a rotary actuator coupled between the first curved section and the second curved section to drive the pivotal movement of the first curved section and the second curved section relative to each other about the hinge axis;
a first continuous track assembly disposed within the main ring and coupled to the first curved section, the first continuous track assembly comprising:
a first moving wagon coupled to the first recessed curved track portion, the first moving wagon configured to be moveable along the first recessed curved track portion, the first moving wagon comprising a rotatable pinion, the rotatable pinion configured to mesh with a rack fitted within the first recessed curved track portion;
a first suspension mechanism mounted on the first moving wagon, the first suspension mechanism comprising at least one elastic member mounted on the first moving wagon; and
a first continuous track mounted on the first moving wagon by utilizing the first suspension mechanism, a first end of the at least one elastic member coupled to the first continues track and an opposing second end of the at least one elastic member coupled to the first moving wagon;
a second continuous track assembly disposed within the main ring and coupled to the second curved section, the first continuous track assembly and the second continuous track assembly configured to engage opposing surfaces of a beam responsive to the beam received within the main ring, the second continuous track assembly comprising:
a second moving wagon coupled to the second recessed curved track portion, the second moving wagon configured to be moveable along the second recessed curved track portion, the second moving wagon comprising a rotatable pinion, the rotatable pinion configured to mesh with a rack fitted within the second recessed curved track portion;
a second suspension mechanism mounted on the second moving wagon, the second suspension mechanism comprising at least one elastic member mounted on the second moving wagon; and
a second continuous track mounted on the second moving wagon by utilizing the second suspension mechanism, a first end of the at least one elastic member coupled to the second continues track and an opposing second end of the at least one elastic member coupled to the second moving wagon; and
a first beam gripping mechanism rotatable mounted on the elongated base section of the elongated telescopic bridge and a second beam gripping mechanism rotatable mounted on the elongated telescoping section of the elongated telescopic bridge;
a beam lifting assembly comprising:
a main pole attached to the elongated telescopic bridge, the main pole extended from the elongated telescopic bridge along an axis parallel to the rotational axis;
a cable;
a cable actuating mechanism coupled to a distal end of the main pole, the cable actuating mechanism further coupled to the cable and configured to extend/retract the cable; and
an end-effector coupled to a distal end of the cable, the end-effector configured to grab a beam;
a clamp rotatably mounted on the elongated telescoping bridge, the clamp comprising:
a fixed clamp section;
a moveable clamp section coupled to the fixed clamp section; and
a linear actuator coupled between the fixed clamp section and the moveable clamp section, the linear actuator configured to drive a linear movement of the moveable clamp section relative to the fixed clamp section;
at least one welding arm assembly comprising:
a robotic arm with six degrees of freedom rotatably attached to the elongated telescopic bridge; and
a welding end-effector coupled to a distal end of the robotic arm.

2. A structure assembling robot, comprising:
an elongated telescopic bridge with an adjustable length along a longitudinal axis of the elongated telescopic bridge;
at least one beam gripping mechanism mounted on the elongated telescopic bridge, the at least one beam gripping mechanism comprising:
a main ring rotatably coupled to the elongated telescopic bridge, the main ring configured to be rotatable about a rotational axis perpendicular to the longitudinal axis of the elongated telescopic bridge, the rotational axis parallel with a circular cross-sectional plane of the main ring, the main ring comprising:
a first curved section; and
a second curved section hinged to the first curved section, the second curved section and the first curved section configured to be pivotable relative to each other about a hinge axis perpendicular to the circular cross-sectional plane of the main ring;
a first continuous track assembly disposed within the main ring and coupled to the first curved section; and
a second continuous track assembly disposed within the main ring and coupled to the second curved section,
the first continuous track assembly and the second continuous track assembly configured to engage opposing surfaces of a beam responsive to the beam received within the main ring;
a beam lifting assembly comprising:
a main pole attached to the elongated telescopic bridge, the main pole extended from the elongated telescopic bridge along an axis parallel to the rotational axis;
a cable;
a cable actuating mechanism coupled to a distal end of the main pole, the cable actuating mechanism further coupled to the cable and configured to extend/retract the cable; and
an end-effector coupled to a distal end of the cable, the end-effector configured to grab a beam;
a clamp rotatably mounted on the elongated telescoping bridge, the clamp comprising:
a fixed clamp section;
a moveable clamp section coupled to the fixed clamp section; and
a linear actuator coupled between the fixed clamp section and the moveable clamp section, the linear actuator configured to drive a linear movement of the moveable clamp section relative to the fixed clamp section;
at least one welding arm assembly comprising:
a robotic arm with six degrees of freedom rotatably attached to the elongated telescopic bridge; and
a welding end-effector coupled to a distal end of the robotic arm.

3. The structure assembling robot of claim 2, wherein elongated telescopic bridge comprises:
an elongated base section extending along the longitudinal axis of the elongated telescopic bridge; and
an elongated telescoping section extending along the longitudinal axis of the elongated telescopic bridge, the elongated telescoping section telescopically received within the elongated base section,
the elongated telescoping section configured to be linearly extended/retracted relative to the elongated base section along the longitudinal axis of the elongated telescopic bridge.

4. The structure assembling robot of claim 2, wherein elongated telescopic bridge further comprises a linear actuator coupled between the elongated base section and the elongated telescoping section, the linear actuator configured to linearly extend/retract the elongated telescoping section relative to the elongated base section along the longitudinal axis of the elongated telescopic bridge.

5. The structure assembling robot of claim 3, wherein the at least one beam gripping mechanism comprises a first beam gripping mechanism rotatable mounted on the elongated base section of the elongated telescopic bridge and a second beam gripping mechanism rotatable mounted on the elongated telescoping section of the elongated telescopic bridge.

6. The structure assembling robot of claim 1, wherein the main ring further comprises a rotatable shaft attached to the main ring from a first end of the rotatable shaft, the main ring rotatable with the rotatable shaft about the longitudinal axis of the rotatable shaft, a longitudinal axis of the rotatable shaft perpendicular to the longitudinal axis of the elongated telescopic bridge and parallel with the rotational axis of the main ring, an opposing second end of the rotatable shaft rotatably coupled to the elongated telescopic bridge.

7. The structure assembling robot of claim 5, wherein the second end of the rotatable shaft is further coupled to a rotary actuator disposed within the elongated telescopic bridge, the rotary actuator configured to drive a rotational movement of the rotatable shaft.

8. The structure assembling robot of claim 6, wherein the main ring further comprises a rotary actuator coupled between the first curved section and the second curved section to drive the pivotal movement of the first curved section and the second curved section relative to each other about the hinge axis.

9. The structure assembling robot of claim 1, wherein the first curved section comprises a first recessed curved track portion extending circumferentially on an inner wall of the first curved section, the first continuous track assembly moveably coupled to the first recessed curved track portion.

10. The structure assembling robot of claim 8, wherein the second curved section comprises a second recessed curved track portion extending circumferentially on an inner wall of the second curved section, the second continuous track assembly moveably coupled to the second recessed curved track portion.

11. The structure assembling robot of claim 9, wherein the first continuous track assembly comprises:
a first moving wagon coupled to the first recessed curved track portion, the first moving wagon configured to be moveable along the first recessed curved track portion;
a first suspension mechanism mounted on the first moving wagon, the first suspension mechanism comprising at least one elastic member mounted on the first moving wagon; and
a first continuous track mounted on the first moving wagon by utilizing the first suspension mechanism, a first end of the at least one elastic member coupled to the first continues track and an opposing second end of the at least one elastic member coupled to the first moving wagon.

12. The structure assembling robot of claim 9, wherein the first moving wagon comprises a rotatable pinion, the rotatable pinion configured to mesh with a rack fitted within the first recessed curved track portion.

13. The structure assembling robot of claim 10, wherein the second continuous track assembly comprises:
a second moving wagon coupled to the second recessed curved track portion, the second moving wagon configured to be moveable along the second recessed curved track portion;
a second suspension mechanism mounted on the second moving wagon, the second suspension mechanism comprising at least one elastic member mounted on the second moving wagon; and
a second continuous track mounted on the second moving wagon by utilizing the second suspension mechanism, a first end of the at least one elastic member coupled to the second continues track and an opposing second end of the at least one elastic member coupled to the second moving wagon.

14. The structure assembling robot of claim 9, wherein the second moving wagon comprises a rotatable pinion, the rotatable pinion configured to mesh with a rack fitted within the second recessed curved track portion.
